(19) United States
(12) Patent Application Publication
(10) Pub. No.: US 2025/0095314 A1
(43) Pub. Date: Mar. 20, 2025

(54) VIRTUAL OBJECT GENERATION METHOD AND APPARATUS, DEVICE, AND STORAGE MEDIUM

(71) Applicant: Beijing Zitiao Network Technology Co., Ltd., Beijing (CN)

(72) Inventors: Jiacheng LIU, Beijing (CN); Xiaoxing CHEN, Beijing (CN)

(21) Appl. No.: 18/730,741

(22) PCT Filed: Jan. 12, 2023
(86) PCT No.: PCT/CN2023/071877

§ 371 Date: Jul. 19, 2024

(30) Foreign Application Priority Data
Jan. 21, 2022 (CN) 202210072404.6

(51) Int. Cl. G06T 19/20

(52) U.S. Cl. CPC G06T 19/20; G06T 2219/2016

(57) ABSTRACT

The present disclosure provides a virtual object generation method, apparatus, device, and storage medium. The method for generating a virtual object comprises: acquiring position information and pose information of a virtual object box in a three-dimensional space; determining size information of the virtual object box in the three-dimensional space according to the pose information; determining a target material according to the size information; and rendering the target material into the virtual object box according to the position information and the pose information to generate a virtual object.

### CROSS-REFERENCE TO RELATED APPLICATION(S)

This application claims priority to Chinese Patent Application No. 202210072404.6, filed with the China National Intellectual Property Administration on Jan. 21, 2022, the disclosure of which is incorporated herein by reference in its entirety.

### FIELD

The present disclosure relates to the technical field of augmented reality, and for example, to virtual object generation method, apparatus, device and a storage medium.

### BACKGROUND

Usually, materials are allocated to respective virtual object boxes according to an order of the materials, and then the material is scaled according to a size of a short edge of the virtual object box to ensure that the material is completely located in the virtual object box. In this way, if a higher material is placed in a wider virtual object box, there is a large space remaining in the virtual object box after the material is scaled, which affects the display effect of a virtual object.

### SUMMARY

The present disclosure provides virtual object generation method, apparatus, device and a storage medium. A material is selected according to a size of a virtual object box, which can improve a size matching degree between the scaled material and the virtual object box, thus improving the display effect of the virtual object.

In a first aspect, the present disclosure provides a method for generating a virtual object, comprising:
acquiring position information and pose information of a virtual object box in a three-dimensional space;
determining size information of the virtual object box in the three-dimensional space according to the pose information;
determining a target material according to the size information; and
rendering the target material into the virtual object box according to the position information and the pose information to generate a virtual object.

In a second aspect, the present disclosure provides an apparatus for generating a virtual object, comprising:
an information acquisition module, configured for acquiring position information and pose information of a virtual object box in a three-dimensional space;
a size information determining module, configured for determining size information of the virtual object box in the three-dimensional space according to the pose information;
a target material determining module, configured for determining a target material according to the size information; and
a virtual object generation module, configured for: rendering the target material into the virtual object box according to the position information and the pose information to generate a virtual object.

In a third aspect, the present disclosure further provides an electronic device. The electronic device comprises:
one or more processing apparatus; and
a storage apparatus, configured for storing one or more programs.

The one or more programs, when executed by the one or more processing apparatus, cause the one or more processing apparatus to implement the method for generating the virtual object.

In a fourth aspect, the present disclosure further provides a computer-readable medium, which stores a computer program, wherein the program, when executed by a processing apparatus, implements the method for generating the virtual object.

In a fifth aspect, the present disclosure further provides a computer program product, comprising a computer program carried on a non-transitory computer-readable medium, wherein the computer program comprises program codes used for implementing the method for generating the virtual object.

### BRIEF DESCRIPTION OF THE DRAWINGS

FIG. 1 is a flowchart of a method for generating a virtual object according to embodiments of the present disclosure;

FIG. 2 is a schematic structural diagram of an apparatus for generating a virtual object according to embodiments of the present disclosure; and

FIG. 3 is a schematic structural diagram of an electronic device according to embodiments of the present disclosure.

### DETAILED DESCRIPTION OF EMBODIMENTS

The embodiments of the present disclosure will be described below with reference to the accompanying drawings. Although the accompanying drawings show some embodiments of the present disclosure, the present disclosure can be implemented in various forms, and these embodiments are provided for understanding the present disclosure. The accompanying drawings and embodiments of the present disclosure are only used for illustration.

Multiple steps recorded in method implementations of the present disclosure can be executed in different orders and/or in parallel. In addition, the method implementations may comprise additional steps and/or omit the execution of the steps shown. The scope of the present disclosure is not limited in this aspect.

The term “comprise” and its variants as used herein mean widespread inclusion, namely, “comprising but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

The concepts such as “first” and “second” mentioned in the present disclosure are only used to distinguish different apparatuses, modules, or units, and are not intended to limit the order or interdependence of the functions performed by these apparatuses, modules, or units.

The modifications of “one” and “a plurality of” mentioned in the present disclosure are indicative rather than restrictive, and those skilled in the art should understand that unless otherwise stated in the context, they should be understood as “one or more”.

Messages or names of information exchanged between a plurality of apparatuses in the implementations of the present disclosure are only for illustrative purposes and are not intended to limit the messages or the scope of the information.

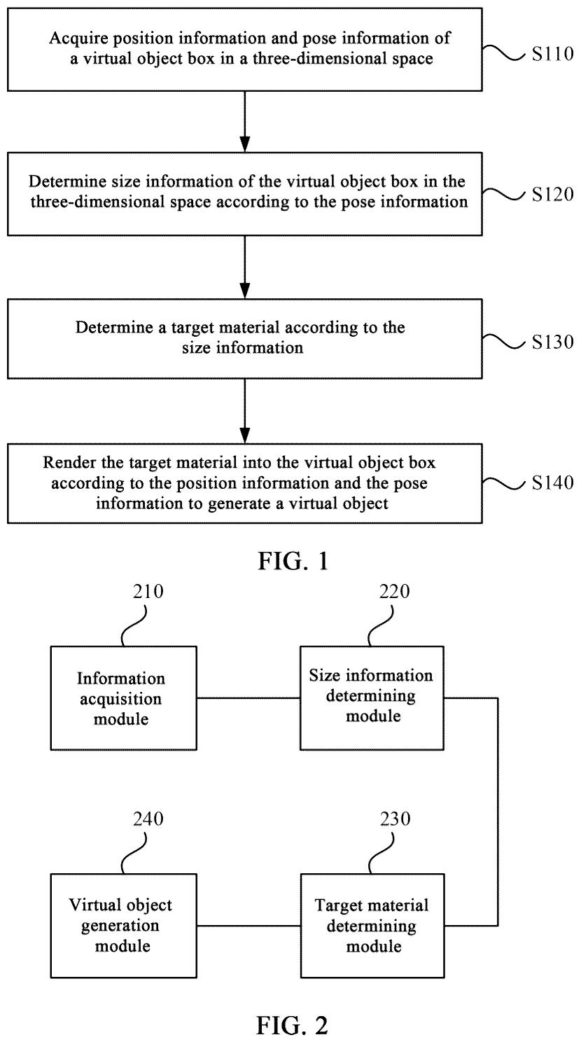

FIG. 1 is a flowchart of a method for generating a virtual object according to embodiments of the present disclosure. These embodiments may be applied in a scenario of generating a virtual object in a picture of a three-dimensional space. The method can be performed by an apparatus for generating a virtual object. The apparatus can comprise hardware and/or software and is generally integrated in a device with a function of generating a virtual object. The device may be a server, a mobile terminal, a server cluster, or another electronic device. As shown in FIG. 1, the method comprises the following steps:

S110. Acquire position information and pose information of a virtual object box in a three-dimensional space.

The virtual object box is hung on an object that is identified in the three-dimensional space and is used for placing a virtual object. There may be a plurality of virtual object boxes. In these embodiments, the virtual object may be a virtual object corresponding to any theme. For example, the theme may be “Dragon Boat Festival”, and the virtual object may be a virtual dragon boat, a virtual Zongzi, and the like, which is not limited here.

The position information may be coordinate information of a center point of the virtual object box in the three-dimensional space, and the pose information may comprise a yaw angle, a pitch angle, and a roll angle of the virtual object box in the three-dimensional space.

In these embodiments, the coordinate information of the center point of the virtual object box in the three-dimensional space may be determined according to simultaneous localization and mapping (SLAM) information, and the pose information of the virtual object box in the three-dimensional space may be determined through a normal estimation algorithm. These embodiments are not limited in this regard.

In these embodiments, the virtual object box may be determined by: performing object detection on a current picture; and determining the virtual object box according to a detected object. A size of the virtual object box may be determined according to a detection box of the object. For example, the size of the virtual object box may be less than or equal to that of the detection box of the object, or the detection box of the object may be divided into a plurality of virtual object boxes.

S120. Determine size information of the virtual object box in the three-dimensional space according to the pose information.

The size information may be a length-to-width ratio. Therefore, it is necessary to acquire a height and a width of the virtual object box in the three-dimensional space, and a ratio is determined between the height and the width to obtain the length-to-width ratio.

Determining the size information of the virtual object box in the three-dimensional space according to the pose information may comprise: determining, according to a first height of the virtual object box in a pixel plane and the pitch angle, a second height of the virtual object box in the three-dimensional space; determining, according to a first width of the virtual object box in the pixel plane and the yaw angle, a second width of the virtual object box in the three-dimensional space; and obtaining the length-to-width ratio of the virtual object box in the three-dimensional space by determining a ratio between the second height and second width.

The first height may be multiplied by a cosine value of the pitch angle to obtain the second height of the virtual object box in the three-dimensional space, and the first width may be multiplied by a cosine value of the yaw angle to obtain the second width of the virtual object box in the three-dimensional space. By determining the length-to-width ratio of the virtual object box in the three-dimensional space according to the pose information, the size information of the virtual object box may be accurately determined, which is beneficial for subsequent selection of a target material.

S130. Determine a target material according to the size information.

The target material may be understood as a material placed in the virtual object box, and the material may be a material of any theme, which is designed and stored by a developer in a material library. In these embodiments, a size of the target material is matched with the size information of the virtual object box in the three-dimensional space.

Determining the target material according to the size information may comprise: determining materials that were not present in a historical period as candidate materials; and determining the target material from the candidate materials according to the size information.

The historical period may be understood as the latest N seconds, and N may be any positive integer. Firstly, materials, that have been rendered to the three-dimensional space within the latest N seconds, in the material library are filtered out. Then, remaining materials are determined as the candidate materials. Finally, the target material is determined from the candidate materials according to the length-to-width ratio of the virtual object box in the three-dimensional space. In this way, it is prevented to present the same material repeatedly within a short period of time, and the diversity of virtual object generation can be improved.

The process of determining the target material from the candidate material according to the size information may be as follows: classifying the candidate materials according to length-to-width ratios to obtain a plurality of material classes; determining a material class corresponding to the virtual object box according to the size information as a target material class; and determining the target material from the target material class.

Categories of the length-to-width ratio may comprise: the length-to-width ratio being greater than 1, the length-to-width ratio being equal to 1, and the length-to-width ratio being less than 1. Therefore, the plurality of material classes may comprise a material class with the length-to-width ratio being greater than 1, a material class with the length-to-width ratio being equal to 1, and a material class with the length-to-width ratio being less than 1. If the length-to-width ratio of the virtual object box in the three-dimensional space is greater than 1, the material class with the length-to-width ratio being greater than 1 may be determined as the target material class. If the length-to-width ratio of the virtual object box in the three-dimensional space is equal to 1, the target material class with the length-to-width ratio being equal to 1 may be determined as the target material class. If the length-to-width ratio of the virtual object box in the three-dimensional space is less than 1, the material class with the length-to-width ratio being less than 1 may be determined as the target material class. Finally, the target material may be determined from the target material class.

Determining the target material from the target material class may comprise: randomly selecting a material from the target material class as the target material; or determining a material with the smallest difference between the length-to-width ratio of the material and the length-to-width ratio of the virtual object as the target material.

If the target material class is the material class with the length-to-width ratio being greater than 1, a material may be randomly selected from the material class with the length-to-width ratio being greater than 1 as the target material. If the target material class is the material class with the length-to-width ratio being equal to 1, a material may be randomly selected from the material class with the length-to-width ratio being equal to 1 as the target material. If the target material class is the material class with the length-to-width ratio being less than 1, a material may be randomly selected from the material class with the length-to-width ratio being less than 1 as the target material. In these embodiments, the target material may be determined based on the classified candidate materials, which can improve the efficiency of determining the target material.

If the target material class is the material class with the length-to-width ratio being greater than 1, a length-to-width ratio of each material in the material class with the length-to-width ratio being greater than 1 is calculated, and a difference between each length-to-width ratio and the length-to-width ratio of the virtual object box is calculated. The material with the smallest difference may be used as the target material. If the target material class is the material class with the length-to-width ratio being less than 1, a length-to-width ratio of each material in the material class with the length-to-width ratio being less than 1 is calculated, and a difference between each length-to-width ratio and the length-to-width ratio of the virtual object box is calculated. The material with the smallest difference may be used as the target material. In these embodiments, the material with the smallest difference may be determined as the target material, which can improve the matching degree between the target material and the virtual object box.

S140. Generate a virtual object by render the target material into the virtual object box according to the position information and the pose information.

The position information may be the coordinate information of the center point of the virtual object box in the three-dimensional space. A center point of the target material may be aligned with the center point of the virtual object box in the three-dimensional space, and the target material may be rendered after adjusting a pose of the target material according to the pose information, thus the virtual object can be obtained.

Rendering the target material into the virtual object box according to the position information and the pose information to generate the virtual object may comprise: acquiring depth information of the virtual object box in the three-dimensional space; scaling the target material according to the depth information; and rendering the scaled target material into the virtual object box according to the position information and the pose information.

The depth information may be a distance between the center point of the virtual object box and an optical center of a camera. The scaling of the target material may be an equal scaling, so that the scaled target material may be completely surrounded by the virtual object box, which prevents the rendered virtual object from exceeding the virtual object box and avoids overlapping with other virtual objects. Scaling the target material based on the depth information can improve the three-dimensionality of the virtual object.

Scaling the target material according to the depth information may comprise: determining a scaling ratio according to the depth information; and scaling the target material according to the scaling ratio.

There is a certain correspondence relationship between the depth information and the scaling ratio. For example, the depth information is directly proportional to the scaling ratio. If the depth information is larger, the scaling ratio is larger, which conforms to the perspective principle. If an object is farther, the size of the object is smaller in a picture.

After the target material is scaled according to the scaling ratio, a center point of the scaled target material is aligned with the center point of the virtual object box in the three-dimensional space, and a pose of the scaled target material is adjusted according to the pose information; and finally, rendering is performed to obtain the virtual object. This way can ensure that the rendered virtual object fits in the virtual object box, which improves the display effect of the virtual object.

According to the technical solutions of the embodiments of the present disclosure, the method comprises: acquiring position information and pose information of a virtual object box in a three-dimensional space; determining size information of the virtual object box in the three-dimensional space according to the pose information; determining a target material according to the size information; and rendering the target material into the virtual object box according to the position information and the pose information to generate a virtual object. According to the method for generating the virtual object provided in the embodiments of the present disclosure, the target material is determined according to the size information of the virtual object box, which can improve a size matching degree between the scaled material and the virtual object box, thus improving the display effect of the virtual object and improving the display quality of an image.

FIG. 2 is a schematic structural diagram of an apparatus for generating a virtual object according to embodiments of the present disclosure. As shown in FIG. 2, the apparatus comprises:
an information acquisition module 210, configured for acquiring position information and pose information of a virtual object box in a three-dimensional space; a size information determining module 220, configured for determining size information of the virtual object box in the three-dimensional space according to the pose information; a target material determining module 230, configured for determining a target material according to the size information; and a virtual object generation module 240, configured for: rendering the target material into the virtual object box according to the position information and the pose information to generate a virtual object.

In an embodiment, the pose information may comprise a yaw angle, a pitch angle, and a roll angle; the size information may be a length-to-width ratio; and the size information determining module 220 may be configured for:
determining, according to a first height of the virtual object box in a pixel plane and the pitch angle, a second height of the virtual object box in the three-dimensional space; determining, according to a first width of the virtual object box in the pixel plane and the yaw angle, a second width of the virtual object box in the three-dimensional space; and obtaining the length-to-width ratio of the virtual object box in the three-dimensional space by determining a ratio between the second height and second width.

In an embodiment, the target material determining module 230 may be configured for:
determining materials that were not present in a historical period as candidate materials; and determining the target material from the candidate materials according to the size information.

In an embodiment, the target material determining module 230 may be configured for:
classifying the candidate materials according to length-to-width ratios to obtain a plurality of material classes; determining a material class corresponding to the virtual object box according to the size information as a target material class; and determining the target material from the target material class.

In an embodiment, the target material determining module 230 may be configured for determining the target material from the target material class by:
randomly selecting a material from the target material class, and determining the material as the target material; or determining a material as the target material, wherein a difference between the length-to-width ratio of the material and the length-to-width ratio of the virtual object box is the smallest.

In an embodiment, the virtual object generation module 240 may be configured for:
acquiring depth information of the virtual object box in the three-dimensional space; scaling the target material according to the depth information; and rendering the scaled target material into the virtual object box according to the position information and the pose information.

In an embodiment, the virtual object generation module 240 may be configured for scaling the target material according to the depth information by:
determining a scaling ratio according to the depth information; and scaling the target material according to the scaling ratio.

The above apparatus can implement the method provided in all the foregoing embodiments of the present disclosure, and has corresponding functional modules for implementing the method and corresponding effects. For technical details not described in these embodiments, refer to the method provided in all the foregoing embodiments of the present disclosure.

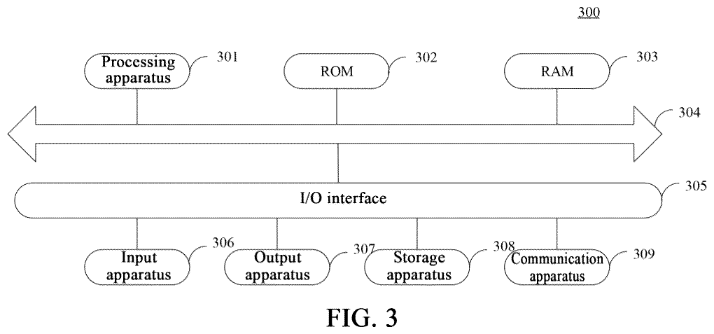

Reference is now made to FIG. 3 below, which illustrates a schematic structural diagram of an electronic device 300 suitable for implementing the embodiments of the present disclosure. The electronic devices in these embodiments of the present disclosure may comprise, but are not limited to, mobile terminals such as a mobile phone, a laptop, a digital broadcast receiver, a personal digital assistant (PDA), a PAD, a portable multimedia player (PMP), and a vehicle-mounted terminal (such as a vehicle-mounted navigation terminal), fixed terminals such as a digital television (TV) and a desktop computers, or servers in various forms, such as an independent server or a server cluster. The electronic device 300 shown in FIG. 3 is only an example and should not impose any limitations on the functionality and scope of use of the embodiments of the present disclosure.

As shown in FIG. 3, the electronic device 300 may comprise a processing apparatus (such as a central processing unit and graphics processor) 301 that can perform various appropriate actions and processing according to programs stored in a Read-Only Memory (ROM) 302 or loaded from a storage apparatus 308 to a Random Access Memory (RAM) 303. Various programs and data required for operations of the electronic device 300 may also be stored in the RAM 303. The processing apparatus 301, the ROM 302, and the RAM 303 are connected to each other through a bus 304. An Input/Output (I/O) interface 305 is also connected to a bus 304.

Usually, following apparatuses may be connected to the I/O interface 305: an input apparatus 306 comprising for example a touch screen, a touchpad, a keyboard, a mouse, a camera, a microphone, an accelerometer, a gyroscope, and the like; an output apparatus 307 comprising for example a Liquid Crystal Display (LCD), a speaker, a vibrator, and the like; a storage apparatus 308 comprising a magnetic tape, a hard disk drive, and the like; and a communication apparatus 309. The communication apparatus 309 can allow the electronic device 300 to wirelessly or wiredly communicate with other devices to exchange data. Although FIG. 3 shows the electronic device 300 with various apparatuses, the electronic device 300 is not required to implement or have all the apparatuses shown, and can alternatively implement or have more or fewer apparatuses.

According to the embodiments of the present disclosure, the process described in the reference flowchart above can be implemented as a computer software program. For example, the embodiments of the present disclosure comprise a computer program product, comprising a computer program carried on a computer-readable medium, and the computer program comprises program codes used for performing a phrase recommendation method. In such an embodiment, the computer program may be downloaded and installed from a network through the communication apparatus 309, or installed from the storage apparatus 308, or installed from the ROM 302. When the computer program is executed by the processing apparatus 301, the above-mentioned functions defined in the methods of the embodiments of the present disclosure are executed.

The computer-readable medium mentioned in the present disclosure can be a computer-readable signal medium, a computer-readable storage medium, or any combination of the computer-readable signal medium and the computer-readable storage medium. The computer-readable storage medium may be, for example, but not limited to, electric, magnetic, optical, electromagnetic, infrared, or semiconductor systems, apparatuses, or devices, or any combination of the above. Examples of the computer-readable storage medium may comprise but are not limited to: an electrical connection with one or more wires, a portable computer disk, a hard disk drive, a Random Access Memory (RAM), a Read-Only Memory (ROM), an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal media may comprise data signals propagated in a baseband or as part of a carrier wave, which carries computer-readable program codes. The propagated data signals may be in various forms, comprising but not limited to: electromagnetic signals, optical signals, or any suitable combination of the above. The computer-readable signal medium may also be any computer-readable medium other than a computer-readable storage medium. The computer-readable signal medium may send, propagate, or transmit programs for use by or in combination with an instruction execution system, apparatus, or device. The program codes contained in the computer-readable medium may be transmitted using any suitable medium, comprising but not limited to: a wire, an optical cable, a Radio Frequency (RF), and the like, or any suitable combination of the above.

In some implementations, clients and servers may communicate using any currently known or future developed network protocol such as a HyperText Transfer Protocol (HTTP), and may intercommunicate and be interconnected with digital data in any form or medium (for example, a communication network). Examples of the communication network comprise a Local Area Network (LAN), a Wide Area Network (WAN), an internet (such as an Internet), a point-to-point network (such as an ad hoc point-to-point network, and any currently known or future developed network.

The computer-readable medium may be comprised in the electronic device or exist alone and is not assembled into the electronic device.

The computer-readable medium carries one or more programs. The one or more programs, when executed by an electronic device, cause the electronic device to: acquire position information and pose information of a virtual object box in a three-dimensional space; determine size information of the virtual object box in the three-dimensional space according to the pose information; determine a target material according to the size information; and generate a virtual object by rendering the target material into the virtual object box according to the position information and the pose information.

Computer program codes for performing the operations of the present disclosure may be written in one or more programming languages or a combination thereof. The above programming languages comprise but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, comprising a LAN or a WAN, or may be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code comprises one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure may be implemented through software or hardware. The name of the unit does not constitute a limitation on the unit itself.

The functions described herein above may be performed, at least in part, by one or a plurality of hardware logic components. For example, non-restrictively, demonstration types of hardware logic components that may be used comprise: a Field Programmable Gate Array (FPGA), an Application Specific Integrated Circuit (ASIC), an Application Specific Standard Part (ASSP), a System on Chip (SOC), a Complex Programmable Logic Device (CPLD), and the like.

In the context of the present disclosure, a machine-readable medium may be a tangible medium that may comprise or store a program for use by an instruction execution system, apparatus, or device or in connection with the instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of the above content. Examples of the machine-readable storage medium may comprise an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

According to one or more embodiments of the embodiments of the present disclosure, an embodiment of the present disclosure discloses a method for generating a virtual object, comprising:
acquiring position information and pose information of a virtual object box in a three-dimensional space;
determining size information of the virtual object box in the three-dimensional space according to the pose information;
determining a target material according to the size information; and
rendering the target material into the virtual object box according to the position information and the pose information to generate a virtual object.

According to one or more embodiments of the embodiments of the present disclosure, the pose information comprises a yaw angle, a pitch angle, and a roll angle; the size information is a length-to-width ratio; and determining size information of the virtual object box in the three-dimensional space according to the pose information may comprise:
determining, according to a first height of the virtual object box in a pixel plane and the pitch angle, a second height of the virtual object box in the three-dimensional space;
determining, according to a first width of the virtual object box in the pixel plane and the yaw angle, a second width of the virtual object box in the three-dimensional space; and
determining a ratio between the second height and the second width to obtain the length-to-width ratio of the virtual object box in the three-dimensional space.

According to one or more embodiments of the embodiments of the present disclosure, determining the target material according to the size information may comprise:
determining materials that were not present in a historical period as candidate materials; and
determining the target material from the candidate materials according to the size information.

According to one or more embodiments of the embodiments of the present disclosure, determining the target material from the candidate materials according to the size information may comprise:
classifying the candidate materials according to length-to-width ratios to obtain a plurality of material classes;
determining a material class corresponding to the virtual object box according to the size information as a target material class; and
determining the target material from the target material class.

According to one or more embodiments of the embodiments of the present disclosure, determining the target material from the target material class may comprise:
randomly selecting a material from the target material class as the target material; or
determining, from the target material class, a material with the smallest difference between the length-to-width ratio of the material and the length-to-width ratio of the virtual object box as the target material.

According to one or more embodiments of the embodiments of the present disclosure, the rendering the target material into the virtual object box according to the position information and the pose information to generate a virtual object may comprise:
acquiring depth information of the virtual object box in the three-dimensional space;
scaling the target material according to the depth information; and
rendering the scaled target material into the virtual object box according to the position information and the pose information.

According to one or more embodiments of the embodiments of the present disclosure, scaling the target material according to the depth information may comprise:
determining a scaling ratio according to the depth information; and
scaling the target material according to the scaling ratio.

1. A method for generating a virtual object, comprising:
acquiring position information and pose information of a virtual object box in a three-dimensional space;
determining size information of the virtual object box in the three-dimensional space according to the pose information;
determining a target material according to the size information; and
rendering the target material into the virtual object box according to the position information and the pose information to generate a virtual object.

2. The method according to claim 1, wherein the pose information comprises a yaw angle, a pitch angle, and a roll angle; the size information is a length-to-width ratio; and determining the size information of the virtual object box in the three-dimensional space according to the pose information comprises:
determining, according to a first height of the virtual object box in a pixel plane and the pitch angle, a second height of the virtual object box in the three-dimensional space;
determining, according to a first width of the virtual object box in the pixel plane and the yaw angle, a second width of the virtual object box in the three-dimensional space; and
obtaining the length-to-width ratio of the virtual object box in the three-dimensional space according to the second height and the second width.

3. The method according to claim 2, wherein determining the target material according to the size information comprises:
determining materials that were not present in a historical period as candidate materials; and
determining the target material from the candidate materials according to the size information.

4. The method according to claim 3, wherein determining the target material from the candidate materials according to the size information comprises:
classifying the candidate materials according to length-to-width ratios to obtain a plurality of material classes;
determining a material class corresponding to the virtual object box according to the size information as a target material class; and
determining the target material from the target material class.

5. The method according to claim 4, wherein rendering the target material into the virtual object box according to the position information and the pose information to generate the virtual object comprises:
randomly selecting, from the target material class, a material as the target material; or
determining, from the target material class, a material with the smallest difference between the length-to-width ratio of the material and the length-to-width ratio of the virtual object box as the target material.

6. The method according to claim 1, wherein rendering the target material into the virtual object box according to the position information and the pose information to generate the virtual object comprises:
acquiring depth information of the virtual object box in the three-dimensional space;
scaling the target material according to the depth information; and
rendering the scaled target material into the virtual object box according to the position information and the pose information.

7. The method according to claim 6, wherein scaling the target material according to the depth information comprises:
determining a scaling ratio according to the depth information; and
scaling the target material according to the scaling ratio.

8-14. (canceled)

15. An electronic device, comprising:
at least one processing apparatus; and
a storage apparatus, configured for storing at least one program,
wherein the at least one program, when executed by the at least one processing apparatus, causes the at least one processing apparatus to:
acquire position information and pose information of a virtual object box in a three-dimensional space;
determine size information of the virtual object box in the three-dimensional space according to the pose information;
determine a target material according to the size information; and
render the target material into the virtual object box according to the position information and the pose information to generate a virtual object.

16. A computer-readable medium, which stores a computer program, wherein the program, when executed by a processing apparatus causes the processing apparatus to:
acquire position information and pose information of a virtual object box in a three-dimensional space;
determine size information of the virtual object box in the three-dimensional space according to the pose information;
determine a target material according to the size information; and
render the target material into the virtual object box according to the position information and the pose information to generate a virtual object.

17. (canceled)

18. The electronic device according to claim 15, wherein the pose information comprises a yaw angle, a pitch angle, and a roll angle; the size information is a length-to-width ratio; and the at least one processing apparatus being caused to determine the size information of the virtual object box in the three-dimensional space according to the pose information comprises being caused to:
determine, according to a first height of the virtual object box in a pixel plane and the pitch angle, a second height of the virtual object box in the three-dimensional space;
determine, according to a first width of the virtual object box in the pixel plane and the yaw angle, a second width of the virtual object box in the three-dimensional space; and
obtain the length-to-width ratio of the virtual object box in the three-dimensional space according to the second height and the second width.

19. The electronic device according to claim 18, wherein the at least one processing apparatus being caused to determine the target material according to the size information comprises being caused to:
determine materials that were not present in a historical period as candidate materials; and
determine the target material from the candidate materials according to the size information.

20. The electronic device according to claim 19, wherein the at least one processing apparatus being caused to determine the target material from the candidate materials according to the size information comprises being caused to:
classify the candidate materials according to length-to-width ratios to obtain a plurality of material classes;
determine a material class corresponding to the virtual object box according to the size information as a target material class; and
determine the target material from the target material class.

21. The electronic device according to claim 20, wherein the at least one processing apparatus being caused to render the target material into the virtual object box according to the position information and the pose information to generate the virtual object comprises being caused to:
randomly select, from the target material class, a material as the target material; or
determine, from the target material class, a material with the smallest difference between the length-to-width ratio of the material and the length-to-width ratio of the virtual object box as the target material.

22. The electronic device according to claim 15, wherein the at least one processing apparatus being caused to render the target material into the virtual object box according to the position information and the pose information to generate the virtual object comprises being caused to:
acquire depth information of the virtual object box in the three-dimensional space;
scale the target material according to the depth information; and
render the scaled target material into the virtual object box according to the position information and the pose information.

23. The electronic device according to claim 22, wherein the at least one processing apparatus being caused to scale the target material according to the depth information comprises being caused to:
determine a scaling ratio according to the depth information; and
scale the target material according to the scaling ratio.

24. The computer-readable medium according to claim 16, wherein the pose information comprises a yaw angle, a pitch angle, and a roll angle; the size information is a length-to-width ratio; and the processing apparatus being caused to determine the size information of the virtual object box in the three-dimensional space according to the pose information comprises being caused to:
determine, according to a first height of the virtual object box in a pixel plane and the pitch angle, a second height of the virtual object box in the three-dimensional space;
determine, according to a first width of the virtual object box in the pixel plane and the yaw angle, a second width of the virtual object box in the three-dimensional space; and
obtain the length-to-width ratio of the virtual object box in the three-dimensional space according to the second height and the second width.

25. The computer-readable medium according to claim 24, wherein the processing apparatus being caused to determine the target material according to the size information comprises being caused to:
determine materials that were not present in a historical period as candidate materials; and
determine the target material from the candidate materials according to the size information.

26. The computer-readable medium according to claim 25, wherein the processing apparatus being caused to determine the target material from the candidate materials according to the size information comprises being caused to:
classify the candidate materials according to length-to-width ratios to obtain a plurality of material classes;
determine a material class corresponding to the virtual object box according to the size information as a target material class; and
determine the target material from the target material class.

27. The computer-readable medium according to claim 26, wherein the processing apparatus being caused to render the target material into the virtual object box according to the position information and the pose information to generate the virtual object comprises being caused to:
randomly select, from the target material class, a material as the target material; or
determine, from the target material class, a material with the smallest difference between the length-to-width ratio of the material and the length-to-width ratio of the virtual object box as the target material.

28. The computer-readable medium according to claim 16, wherein the processing apparatus being caused to render the target material into the virtual object box according to the position information and the pose information to generate the virtual object comprises being caused to:
acquire depth information of the virtual object box in the three-dimensional space;
scale the target material according to the depth information; and
render the scaled target material into the virtual object box according to the position information and the pose information.
